(19) United States
(12) Patent Application Publication
(10) Pub. No.: US 2023/0001794 A1
(43) Pub. Date: Jan. 5, 2023

(54) METHOD AND DEVICE FOR ASCERTAINING A STATE OF HEALTH OF A BATTERY FOR A MEANS OF TRANSPORTATION

(71) Applicant: Robert Bosch GmbH, Stuttgart (DE)

(72) Inventors: Christian Simonis, Leonberg (DE); Christoph Woll, Gerlingen (DE)

(21) Appl. No.: 17/777,678

(22) PCT Filed: Nov. 25, 2020
(86) PCT No.: PCT/EP2020/083334

§ 371 Date: May 18, 2022

(30) Foreign Application Priority Data
Nov. 28, 2019 (DE) 10 2019 218 436.7

(51) Int. Cl. B60L 3/00; B60L 58/16; B60L 3/12; B60L 58/22; B60L 53/66; H01M 10/44; H01M 10/48; H01M 10/42; H02J 7/00

(52) U.S. Cl. CPC B60L 3/0046; B60L 58/16; B60L 3/12; B60L 58/22; B60L 53/66; H01M 10/44; H01M 10/486; H01M 10/425; H02J 7/005; H02J 7/0014; H02J 7/007182; B60L 2240/547; B60L 2240/70; B60L 2240/545; H01M 2010/4271; H01M 2010/4278; H01M 2220/20

(57) ABSTRACT

A method and to a device for ascertaining a state of health of a battery for a transportation device. The method includes: charging the battery until a predefined target voltage is reached in a first charging phase of the battery, ascertaining a first voltage value of the battery at a first predefined point in time after the predefined target voltage has been reached in a relaxation phase of the battery, ascertaining a second voltage value of the battery at a second predefined point in time, deviating from the first predefined point in time, in the relaxation phase of the battery, ascertaining a piece of information about the state of health of the battery based on a change of the second voltage value with respect to the first voltage value, and using the piece of information in the transportation device and/or in an external server.

### FIELD

The present invention relates to a method and to a device for ascertaining a state of health of a battery for a means of transportation (transportation device).

### BACKGROUND INFORMATION

Different types of electrically driven means of transportation are available in the related art, such as, e.g., passenger cars, trucks, buses, rail vehicles, shuttle vehicles, e-bikes, etc., which ensure the electrical energy supply of these battery-based means of transportation. Due to aging influences, a performance capability of such batteries decreases over time so that, e.g., a range of these means of transportation decreases with an increasing aging state. The aging state or also state of health (SOH in short) of a battery depends on different influencing factors, such as a power throughput through respective cells of the battery, a number and depth of cell charging and cell discharging cycles, a maximum charge and discharge current, thermal circuits (cooling and/or heating systems), a respective operating temperature, etc. All these factors may impact a respective state of health of the battery in different forms and with different weightings. An exact determination of the SOH value is generally difficult and may be associated with considerable complexity with respect to a required sensor system and software. A conventional calculation model from the related art for ascertaining the SOH may, for example, be present in a battery control unit (BCU). In addition to a respective temperature of the battery, such a model may usually also take a respective charge state (state of charge, SOC) into consideration, which may also be derived from a calculation model. A value ascertained in this way for the state of health of the battery is consequently always subject to a certain inaccuracy. A determination of the SOH in certain operating states is additionally not reliable enough since a usage history of the battery (e.g., a current load, a temperature profile, etc.) and a respective instantaneous charge state may differ in individual operating states.

With respect to a use of the battery, it is desirable to be able to take an early recognition of a battery aging into consideration with respect to a future usage of the means of transportation, by which a service life of the battery may be extended.

PCT Patent Application No. WO 2017163089 describes a method and a system for estimating an open circuit potential of a battery based on a predefined temporally variable component of the current and a detected voltage. Based thereon, a function may be calculated for each cell, which puts a ratio of time derivatives of a measured degree of a heat generation and a voltage to the open circuit potential in relation. From this, a measure of the state of health of the battery may be ascertained for each cell.

U.S. Patent Application No. US 2016/214500 describes a method and a device for estimating an SOH value based on a determination of different voltage increase profiles after a relaxation phase and at a low charge rate (C rate) in a charging interval. This is followed by an alternate charging at a normal charge rate and at a low charge rate in a charging interval during a charging process (i.e., a plurality of charging processes is carried out until the battery is fully charged).

It is an object of the present invention to provide a method and a device for ascertaining a state of health of a battery for a means of transportation, a particularly precise determination of the state of health of the battery being thereby achieved.

### SUMMARY

According to a first aspect of the present invention, a method for ascertaining a state of health of a battery for a means of transportation (transportation device) is provided. The means of transportation may, for example, be a road vehicle (e.g., a shuttle, bus, motorcycle, passenger car, delivery van, truck) or a rail vehicle or an aircraft/airplane and/or a water craft. The battery may preferably be a lithium-ion battery for supplying a drive train of the means of transportation, whose end-of-charge voltage is typically in a range of 4.0 V to 4.35 V. It shall be pointed out that battery types deviating therefrom, including end-of-charge voltages deviating therefrom, may also be used in connection with the present method.

In a first step of the method according to an example embodiment of the present invention, the battery is charged until a predefined target voltage is reached in a first charging phase of the battery, the first charging process preferably being a charging process using a constant charge current (also referred to as CC charging). This charging process may, for example, be controlled or regulated by an evaluation unit according to the present invention in conjunction with a charger of the means of transportation or in conjunction with an external charger away from the means of transportation. For example, the evaluation unit may be situated in a battery management system of the battery or in a component deviating therefrom of the means of transportation. Such a battery management system may be situated within or at the housing of the battery, or also outside the battery. The evaluation unit may preferably be configured, based on a computer program, to carry out this and subsequently described method steps according to the present invention. A value for the predefined target voltage may, for example, be stored in an internal or external memory unit which is connected to the evaluation unit in terms of information technology, the predefined target voltage corresponding to a voltage value in the range of 80% to 100%, in particular in the range of 85% to 98%, and preferably in the range of 90% to 97% of the end-of-charge voltage of the battery. For example, the end-of-charge voltage of the battery may correspond to a voltage value of 4.25 V, while a value for the target voltage in the first charging phase may correspond to a voltage value of 4.1 V. An instantaneous voltage value of the battery or instantaneous voltage values of cells of the battery may, for example, be detected with the aid of a sensor system of the battery which is connected to the evaluation unit in terms of information technology, and may be compared to the predefined target voltage with the aid of the evaluation unit.

In a second step of the method according to an example embodiment of the present invention, a first voltage value of the battery is ascertained at a first predefined point in time after the predefined target voltage has been reached in a relaxation phase of the battery. The first voltage value may preferably be detected immediately or after several seconds have elapsed, in response to the termination of the first charging phase. In this way, it may be ensured that an overall duration of the method according to the present invention is as short as possible. A time period between the point in time at which the first charging phase is ended and the first predefined point in time should preferably be a constant predefined time period of, for example, 5 s, so that a repeated ascertainment of the state of health of the battery based on the method according to the present invention may always be carried out based on identical starting conditions. The ascertained first voltage value may, for example, be stored in the memory unit connected to the evaluation unit.

In a third step of the method according to an example embodiment of the present invention, a second voltage value of the battery is ascertained at a second predefined point in time deviating from the first predefined point in time in the relaxation phase of the battery. A time period between the first predefined point in time and the second predefined point in time should preferably also be a constant predefined time period, and a maximum value for this time period should not be selected to be greater than an average relaxation phase for the battery. Such a value for the maximum time period may, for example, be in a range of 20 minutes to 30 minutes. The ascertained second voltage value may also be stored in the memory unit connected to the evaluation unit.

In a fourth step of the method according to an example embodiment of the present invention, a piece of information about the state of health of the battery is ascertained with the aid of the evaluation unit, based on a change in the second voltage value with respect to the first voltage value. The ascertainment of the change may take place by an ascertainment of a difference between the first voltage value and the second voltage value and/or by an ascertainment of a gradient (i.e., a respective slope of a voltage profile curve) based on the first voltage value, the second voltage value, and the time period between the first predefined point in time and the second predefined point in time. In particular, in the case of an ascertainment of the change based on the described gradient, it may be advantageous to select the time period between the first predefined point in time and the second predefined point in time as short as possible, to be able to keep the overall duration of the method according to the present invention accordingly short. For example, a time period suitable therefor may be in the range between 1 min and 10 min and may preferably correspond approximately to 5 min. In this connection, it is crucial that the time period is selected large enough to be able to identify characteristic differences between respective gradients of different aging states or states of health of the battery. Moreover, it is also possible to form the above-described difference between the first voltage value and the second voltage value based on a time period between the respective voltage measurements in the range of 1 min and 10 min. It shall be pointed out that, within the meaning of the method according to the present invention, it is also possible to use time periods deviating therefrom (e.g., smaller than 1 min or greater than 10 min) between the respective voltage measurements, both for forming the difference and for ascertaining the gradient. Respective results of the ascertainment of the difference and/or of the gradient may, for example, be compared to a predefined table, which may be stored in the memory unit connected to the evaluation unit. The table may encompass an assignment between respective values for the difference and/or the gradient and states of health of the battery corresponding to the respective values. In this way, the evaluation unit may ascertain an instantaneous state of health of the battery based on the table. The table may, for example, be created in a development phase of the means of transportation and/or in a test phase of the battery etc., in that suitable reference values for the aging of the battery are documented therein.

In a fifth step of the method according to an example embodiment of the present invention, the piece of information about the state of health of the battery is used in the means of transportation and/or in an external server. For this purpose, the evaluation unit may provide the piece of information about the state of health, for example, via a data bus. (e.g., CAN bus) of a vehicle electrical system of the means of transportation in the means of transportation. As an alternative or in addition, the evaluation unit may also use the piece of information about the state of health itself. Specific usage options of this piece of information in the means of transportation are described in greater detail hereafter in the course of the description of advantageous embodiments of the present invention.

It shall be pointed out that it is possible to ensure based on the method according to an example embodiment of the present invention that, by carrying out the first charging phase, essentially comparable starting states (e.g., by cooling or heating of the battery, etc.) are achieved prior to a respective ascertainment of the state of health of the battery, by which a reliability and an accuracy of the ascertainment of the state of health compared to the related art may be increased. It shall also be pointed out that, e.g., a level of a charge current used in the first charging phase may be adapted, as a function of respective starting conditions, prior to the start of the first charging phase in such a way that particularly comparable boundary conditions prevail in the battery (e.g., a certain temperature, etc.) at the time the end of the first charging phase is reached. As an alternative or in addition to the adaptation of the charge current, it is also possible to use further influencing variables, such as, e.g., a temperature control using a battery heating/cooling, etc., to be able to establish boundary conditions which are as comparable as possible at the end of the first charging phase for the battery.

Preferred refinements of the present invention are disclosed herein.

In one advantageous example embodiment of the present invention, the method, in response to the termination of the relaxation phase of the battery, additionally encompasses charging the battery in a second charging phase until the end-of-charge voltage of the battery is reached. The second charging phase may encompass renewed charging with the aid of a constant charge current and/or charging with the aid of a constant charge voltage (also referred to as CV charging), as a function of a difference between the predefined target voltage and/or as a function of a relaxation-induced voltage decrease of the battery and/or as a function of further criteria. The second charging phase is accordingly used for fully charging the battery so that, in a subsequent usage phase of the battery, a maximum storable electrical energy may be provided.

In another advantageous example embodiment of the present invention, the method additionally encompasses ascertaining a cell balancing need of the battery, and carrying out a cell balancing as a function of the ascertained cell balancing need. The cell balancing may be carried out immediately prior to the first charging phase and/or in response to the termination of the relaxation phase. The cell balancing need may be ascertained by the evaluation unit in that deviations between instantaneous voltages of respective cells of the battery are detected based on the sensor system of the battery. In the event that the deviations of the voltages, for example, exceed a predefined threshold value, the cell balancing may be initiated by the evaluation unit. A passive cell balancing may preferably be carried out here, an active cell balancing also being possible. As a result of the cell balancing, it may be ensured that deviating voltages or charge states of the cells among one another, due to cells having high voltages, do not lead to a premature termination of the first and/or second charging phases.

In another advantageous example embodiment of the present invention, the ascertainment of the state of health is only carried out when a charge state of the battery, prior to the charging in the first charging phase, corresponds to a predefined minimum charge state and/or a temperature of the battery is within a predefined temperature range. In this way, it may be ensured that the starting conditions, prior to the method according to the present invention being carried out again, have as few deviations from one another as possible, so that the ascertainment of the state of health of the battery after the first charging phase may always be carried out based on sufficiently similar boundary conditions. In other words, it may thus be ensured that different usage histories prior to the start of the ascertainment of the state of health of the battery essentially cannot affect the ascertainment of the state of health, or only to a very low degree. The minimum charge state to be adhered to may, for example, be in a range of 40% to 60% and may preferably correspond to a value of approximately 50%. Values deviating therefrom may also be used within the meaning of the method according to the present invention. Prior to the first charging phase, a temperature of the battery should correspond to a temperature between 5° C. and 45° C., preferably between 10° C. and 35° C., and, in particular, between 20° C. and 30° C. Within the meaning of the method according to the present invention, however, temperature ranges and/or temperature values deviating therefrom may also be used. Since the relaxation behavior of the battery is highly dependent on the instantaneous temperature of the battery, it may be particularly advantageous, despite the aforementioned limited temperature ranges, to keep a multitude of temperature-based characteristic curves available for the relaxation behavior of the battery in a characteristic map, which may be automatically selected by the evaluation unit, as a function of the instantaneous temperature of the battery, and be used in each case for the ascertainment of the state of health of the battery. Such a characteristic map may, for example, also be stored in the memory unit connected to the evaluation unit.

In another advantageous example embodiment of the present invention, a predefined target temperature is established for the battery prior to the start of the relaxation phase. A value for the target temperature may also be stored in the memory unit connected to the evaluation unit. The target temperature may preferably be established while the first charging phase is being carried out so that the target temperature of the battery is present after completion of the first charging phase. A regulation of the temperature of the battery may, in particular, take place using an aforementioned battery heating and/or cooling. Such an active temperature regulation may be carried out during the entire first charging phase or only in a portion of the first charging phase. Moreover, a regulation of the battery temperature may already be started prior to the first charging phase. As an alternative or in addition, the temperature of the battery may also be regulated by adapting the respective charge current of the battery, in this case preferably only minor fluctuations of the charge current being used to still keep an influence of the usage history of the battery as low as possible.

In another advantageous example embodiment of the present invention, the charging of the battery takes place based on an AC charging process (alternating current charging) or based on a DC charging process (direct current charging). This may apply both to the first charging phase and to the second charging phase.

In another advantageous example embodiment of the present invention, the piece of information about the state of health is used to compare the state of health of the battery to respective states of health of a multitude of batteries of further means of transportation. For this purpose, the piece of information about the state of health, as mentioned above, may be transferred to an external server. This may take place, for example, with the aid of a wireless communication device of the means of transportation, which may be connected to the evaluation unit according to the present invention in terms of information technology. By the server comparing corresponding pieces of information about states of health of a multitude of means of transportation to one another with the aid of suitable algorithms, it is possible to carry out plausibility checks of respective pieces of information of different means of transportation with one another. As an alternative or in addition, it is possible to automatically adapt, if needed, values of a table, which, as described above, may encompass an assignment between respective values for a difference and/or a gradient and a state of health of a battery corresponding to the respective values, based on a multitude of pieces of information. Preferably, separate tables may be kept available in each case for similar or identical types of means of transportation. These adapted tables may subsequently be used to carry out plausibility checks of the multitude of pieces of information about the states of health of respective batteries within the server. As an alternative or in addition, the adapted tables may also be transferred in a means of transportation-specific manner to respective corresponding means of transportation with the aid of a wireless communication link, so that the means of transportation are able to subsequently carry out the method according to the present invention based on the adapted tables. In this way, potential deviations of signs of aging of batteries from the values previously used in the means of transportation may be taken into consideration, by which the reliability and/or accuracy of the ascertainment of the state of health of the battery may be further enhanced. It shall be pointed out that a use of tables for above-described assignments is only one exemplary embodiment of the present invention. The assignment may also take place based on arbitrary data sets deviating therefrom. As an alternative or in addition to above-described steps, the step of ascertaining the state of health of the battery may also be carried out by the server itself in that the respective means of transportation transfer their respective measured first and second voltage values, the time period between the measurements and, if necessary, further pieces of information (e.g., instantaneous temperature values of the battery, etc.), to the server.

Furthermore, a respective classification of the instantaneous state of health may also take place based on a machine learning method. This may take place both in the means of transportation and in the server. Due to the multitude of pieces of information present in the server, this embodiment may be used particularly advantageously in the server.

In another advantageous example embodiment of the present invention, an information message is output to a driver of the means of transportation as a function of a result of the ascertainment of the state of health of the battery. The information message may encompass a recommendation for a future charging behavior (e.g., a maximum recommended number of further rapid charging processes) and/or a future driving behavior and/or future usage time periods and/or a point in time for a battery replacement. The information message may, for example, be output in a display of a combination instrument and/or of a head unit and/or of a head-up display etc., of the means of transportation. As an alternative or in addition, the information message may also be output in the form of an acoustic output via speakers of the means of transportation. As an alternative or in addition to the output of the information message, usage options of the means of transportation may also be automatically adapted based on predefined criteria. Such an adaptation may, for example, encompass a limitation of a maximum power withdrawal from the battery and/or further measures, which may entail an extension of a service life of the battery.

According to a second aspect of the present invention, a device for ascertaining a state of health of a battery for a means of transportation is provided. In accordance with an example embodiment of the present invention, the device includes an evaluation unit including a data input and a data output. The evaluation unit may, for example, be configured as an ASIC, a FPGA, a processor, a digital signal processor, a microcontroller, or the like, and may be connected to an internal and/or external memory unit in terms of information technology. In conjunction with the data input, the evaluation unit is configured to charge the battery until a predefined target voltage is reached in a first charging phase of the battery, to ascertain a first voltage value of the battery at a first predefined point in time after the predefined target voltage has been reached in a relaxation phase of the battery, to ascertain a second voltage value of the battery at a second predefined point in time, deviating from the first predefined point in time, in the relaxation phase of the battery, and to ascertain a piece of information about the state of health of the battery based on a change in the second voltage value with respect to the first voltage value. In conjunction with the data output, the evaluation unit is additionally configured to use the piece of information about the state of health of the battery in the means of transportation and/or in an external server.

### BRIEF DESCRIPTION OF THE DRAWINGS

Exemplary embodiments of the present invention are described hereafter in greater detail with reference to the figures.

FIG. 1 shows a flowchart illustrating steps of one exemplary embodiment of a method according to the present invention.

FIG. 2 shows a diagram illustrating profiles of a voltage, of a current, and of a charge state while a method according to the present invention is carried out for ascertaining a state of health of a battery.

FIG. 3 shows a schematic overview of a device according to the present invention in conjunction with a means of transportation.

### DETAILED DESCRIPTION OF EXAMPLE EMBODIMENTS

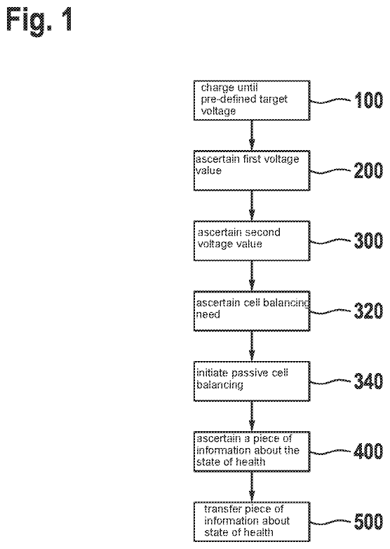

FIG. 1 shows a flowchart illustrating steps of one exemplary embodiment of a method according to the present invention for ascertaining a state of health of a battery for a means of transportation. In step 100 of the method according to the present invention, a lithium-ion high-voltage battery is charged, in conjunction with an evaluation unit according to the present invention, which is a microcontroller here, until a predefined target voltage of 4.1 V is reached in a first charging phase of the battery. In step 200 of the method according to the present invention, a first voltage value of the battery is ascertained at a first predefined point in time after the predefined target voltage has been reached in a relaxation phase of the battery. Since the ascertainment of the first voltage value takes place immediately after completion of the first charging phase, the first voltage value here corresponds to the value of the target voltage of 4.1 V. In step 300 of the method according to the present invention, a second voltage value of the battery is ascertained at a second predefined point in time, deviating from the first predefined point in time, in the relaxation phase of the battery. Here, the second voltage value is ascertained 20 minutes after the ascertainment of the first voltage value. The second voltage value corresponds to a value of 3.8 V. In step 320 of the method according to the present invention, a cell balancing need of the battery is ascertained after the relaxation phase has ended. Due to a relatively large variance of the voltage values of respective cells of the battery, in step 340 of the method according to the present invention a passive cell balancing is initiated by the evaluation unit. After completion of the cell balancing, in step 400 of the method according to the present invention, a piece of information about the state of health of the battery is ascertained with the aid of the evaluation unit, based on a change of the second voltage value with respect to the first voltage value. For this purpose, a difference between the first voltage value and the second voltage value of 0.3 V is calculated with the aid of the evaluation unit. Thereafter, the evaluation unit compares the value for the difference to an assignment table, which is stored in a memory unit connected to the evaluation unit in terms of information technology. Based on the assignment table, a good state of health is ascertained for the battery due to the small difference between the first and second voltage values. In step 500 of the method according to the present invention, the ascertained piece of information about the state of health of the battery is transferred with the aid of the evaluation unit via a vehicle electrical system of the means of transportation to a combination instrument of the means of transportation, in which the piece of information about the state of health of the battery is displayed in the form of an information text.

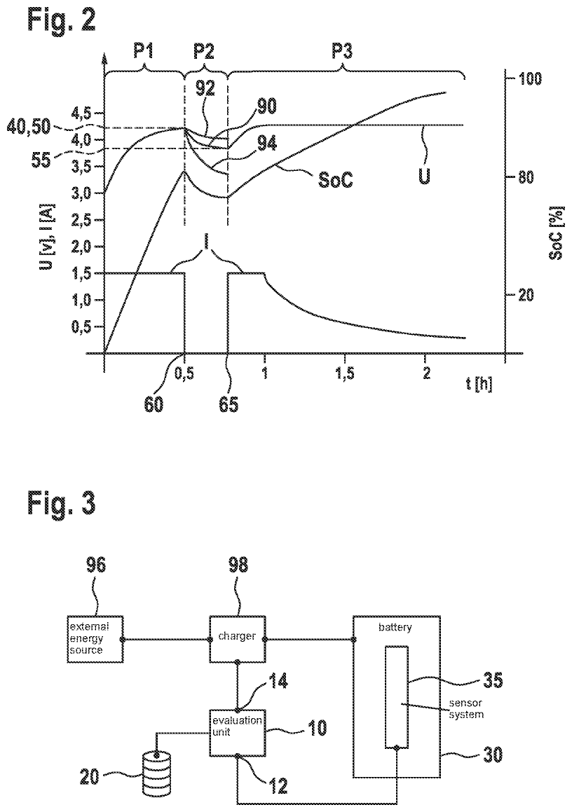

FIG. 2 shows a diagram illustrating profiles of a voltage U, of a current I, and of a charge state SoC while a method according to the present invention is being carried out for ascertaining a state of health of a battery. In a first charging phase P1, the battery is charged at a constant charge current (CC charging) of 1.5 A until a target voltage 40 of 4.1 V is reached. In a relaxation phase P2 following the first charging phase P1, among other things, a first relaxation behavior 90 of the battery is shown, which corresponds to a good state of health of the battery. The state of health of the battery is ascertained based on a voltage difference between a first voltage value 50, which is measured at a first point in time 60 (start of relaxation phase P2), and a second voltage value 55, which is measured at a second point in time 65 (end of relaxation phase P2). Additionally, a second relaxation behavior 92 and a third relaxation behavior 94 are shown by way of example, which the battery may have at different aging states. Second relaxation behavior 92 corresponds to a very good state of health, while third relaxation behavior 94 corresponds to a poor state of health of the battery. In a second charging phase P3, the battery is initially again charged at a constant charge current of 1.5 A, followed by a charging with a constant voltage (CV charging), until a maximum charge state SoC of the battery is reached. In the event that the relaxation behavior of the battery corresponds to second relaxation behavior 92 or third relaxation behavior 94, voltage curve U is accordingly continuously continued in second charging phase P3, proceeding from the end value of the respective voltage of the respective relaxation behavior 92, 94 (not shown).

FIG. 3 shows a schematic overview of a device according to the present invention in conjunction with a means of transportation. The device includes an evaluation unit 10, which is an ASIC here and which includes a data input 12 and a data output 14. Evaluation unit 10 is additionally connected to a memory unit 20 in terms of information technology. With the aid of data input 12, evaluation unit 10 is connected to a sensor system 35 of a battery 30 of the means of transportation in terms of information technology. With the aid of data output 14, evaluation unit 10 is connected to a charger 98 of the means of transportation, which is connected between an external energy source 96 (charging station) and battery 30. Based on this configuration, the device according to the present invention is configured to carry out above-described method steps according to the present invention to ascertain an instantaneous state of health of battery 30. The method steps are implemented with the aid of a computer program, which is executed by evaluation unit 10.

1-11. (canceled)

12. A method for ascertaining a state of health of a battery for a transportation device, comprising the following steps:
charging the battery until a predefined target voltage is reached in a first charging phase of the battery;
ascertaining a first voltage value of the battery at a first predefined point in time after the predefined target voltage has been reached in a relaxation phase of the battery;
ascertaining a second voltage value of the battery at a second predefined point in time, deviating from the first predefined point in time, in the relaxation phase of the battery;
ascertaining a piece of information about a state of health of the battery based on a change of the second voltage value with respect to the first voltage value; and
using the piece of information about the state of health of the battery in transportation device and/or in an external server.

13. The method as recited in claim 12, wherein the predefined target voltage corresponds to a voltage value in a range of 80% to 100% of an end-of-charge voltage of the battery.

14. The method as recited in claim 13, wherein the range is of 85% to 98% of the end-of-charge voltage of the battery.

15. The method as recited in claim 13, wherein the range is of 90% to 97% of the end-of-charge voltage of the battery.

16. The method as recited in claim 12, further comprising:
charging the battery in a second charging phase until an end-of-charge voltage of the battery is reached in response to a termination of the relaxation phase of the battery.

17. The method as recited in claim 12, further comprising:
ascertaining a cell balancing need of the battery; and
carrying out a cell balancing as a function of the ascertained cell balancing need, the cell balancing being carried out:
immediately prior to the first charging phase, and/or
in response to a termination of the relaxation phase.

18. The method as recited in claim 12, wherein the ascertainment of the state of health is carried out only when:
a charge state of the battery, prior to the charging in the first charging phase, corresponds to a predefined minimum charge state, and/or
a temperature of the battery is within a predefined temperature range.

19. The method as recited in claim 12, wherein a predefined target temperature for the battery is established prior to a start of the relaxation phase.

20. The method as recited in claim 12, wherein the change of the second voltage value with respect to the first voltage value is ascertained based on a difference, and/or a gradient.

21. The method as recited in claim 12, wherein the charging of the battery takes place based on an AC charging process or a DC charging process.

22. The method as recited in claim 12, wherein the piece of information about the state of health of the battery is used to:
compare the state of health of the battery to respective states of health of a multitude of batteries of further transportation devices, and/or
automatically classify it into a state of health class using a machine learning method.

23. The method as recited in claim 12, wherein, as a function of a result of the ascertainment of the state of health of the battery:
an information message is output to a driver of the transportation device, the information message encompassing a recommendation for a future charging behavior, and/or a future driving behavior, and/or future usage time periods, and/or a point in time for a battery replacement; and/or
usage options of the transportation device are automatically adapted based on predefined criteria.

24. A device for ascertaining a state of health of a battery for a transportation device, comprising:
an evaluation unit;
a data input; and
a data output;
wherein the evaluation unit is configured, in conjunction with the data input, o charge the battery until a predefined target voltage is reached in a first charging phase of the battery, to ascertain a first voltage value of the battery at a first predefined point in time after the predefined target voltage has been reached in a relaxation phase of the battery, to ascertain a second voltage value of the battery at a second predefined point in time, deviating from the first predefined point in time, in the relaxation phase of the battery, and to ascertain a piece of information about the state of health of the battery based on a change of the second voltage value with respect to the first voltage value, and in conjunction with the data output, to use the piece of information about the state of health of the battery in the transportation device and/or in an external server.
